(19) United States
(12) Patent Application Publication
(10) Pub. No.: US 2008/0105470 A1
(43) Pub. Date: May 8, 2008

(54) Touch Screen Slider for Setting Floating Point Value

(75) Inventors: Ramon Eugene Franciscus Van De Ven, Eindhoven (NL); Galileo June Destura, Eindhoven (NL); Michael Heesemans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,926

(22) PCT Filed: Jul. 21, 2005
(86) PCT No.: PCT/IB05/52452

§ 371 Date: Jan. 30, 2007

(30) Foreign Application Priority Data
Aug. 2, 2004 (EP) 04103704.5

(51) Int. Cl. G06F 3/041; G06K 11/00

(52) U.S. Cl. 178/18.01

(57) ABSTRACT

A data processing system comprises a pressure-sensitive input device for assigning a floating-point value to a parameter under control of a pressure applied to the device. The system is operative to detect a rate of change of the pressure to control the assigning, e.g., to validate the current value as being input or to unlock the value as set.

### FIELD OF THE INVENTION

The invention relates to a data processing system with a pressure-sensitive input device, e.g., a pressure-sensitive or force-sensitive touch screen, for enabling a user to input data. The invention also relates to a device for use in such a system, to a method of enabling to input data into a data processing system through a pressure sensitive device and to control software for use on aforesaid system.

### BACKGROUND ART

Force- or pressure-sensitive touch screens are known from, e.g., U.S. Pat. No. 5,541,372 (attorney docket PHN 14086) on “FORCE ACTIVATED TOUCH SCREEN MEASURING DEFORMATION OF FRONT PANEL; U.S. Pat. No. 5,510,813 (attorney docket PHN 14550) on “DATA PROCESSING DEVICE COMPRISING A TOUCH SCREEN AND A FORCE SENSOR”; EP-A 0 595 746 on “METHOD AND SYSTEM FOR INPUT DEVICE PRESSURE INDICATION IN A DATA PROCESSING SYSTEM, all incorporated herein by reference. Such touch screens allow for an input with three degrees of freedom, namely the coordinates of the location where the user touches the screen's surface area plus the magnitude of the force or pressure sensed by the touch screen.

### SUMMARY OF THE INVENTION

The inventors have realized that the known touch screens do not let the user conveniently set a value on a real scale such as with a virtual slider on a graphical user interface to adjust, e.g., the volume of the music being played out. In such an application increasing the pressure should raise the value and decreasing the pressure should lower the value, thus providing an intuitive and easy manner to work with the apparatus to be controlled through the user interface. It would also be a good solution to the problem of using the screen's real estate efficiently, as a single (virtual) button would be needed instead of one for increasing and another for decreasing the value.

The inventors therefore propose to use a single button for inputting a real value into a data processing system. Pressing the button controls the value. Increasing the pressure raises the value and decreasing the pressure lowers it. However, provisions have to be made to validate, or confirm, a setting of the value as releasing the button decreases the pressure and hence lowers the value previously set. The inventors therefore propose to determine whether or not a pressure decrease over a certain range occurred within a certain time interval. If it did, then the decrease is interpreted as validating the setting present at the start of the rapid pressure decrease. If it did not, then the decrease is interpreted as lowering the real value accordingly.

In order to be able to lower a value set previously, pressure has to be applied first to be able to lower the pressure and to thereby set a new lower value. The inventors therefore propose an unlock mechanism to reset a value set (i.e., locked) previously. An implementation for the unlocking mechanism requires the user to first apply a pressure larger than the pressure corresponding to the value as set. Preferably, the user is given a visual or auditory feedback to signal that the required pressure level has been reached so that the user can start resetting the value as specified above. In another implementation, the user is to apply a rapidly increasing pressure to the button to unlock the setting. That is, not the magnitude of the pressure but its rate of change is used to signify the intention to unlock.

Accordingly, the invention relates to a data processing system comprising a pressure-sensitive input device for assigning a real value to a parameter under control of a pressure applied to the device. The system is operative to detect a rate of change of the pressure to control the assigning. Preferably, the system is operative to set the parameter to the value assigned prior to detecting the rate of change being larger than a predetermined rate. In an embodiment, the system is operative to render the value, previously assigned, changeable upon detecting the rate of change being larger than a predetermined value. Alternatively, the system is operative to render the value, previously assigned, changeable upon detecting a first magnitude of the pressure being larger than a second magnitude of the pressure corresponding to the assigned value. Preferably, the device comprises a touch screen. The system may be accommodated in a remote control device, e.g., for control of consumer electronics equipment in a home environment; in a handheld or laptop PC; in a cell phone, etc.

The invention also relates to a pressure-sensitive input device for assigning a real value to a parameter under control of a pressure applied to the device. The device is operative to detect a rate of change of the pressure to control the assigning. Embodiments of the device in the invention correspond to the ones of the system described above. The invention also relates to a method of enabling to assign a real value to a parameter under control of a pressure applied to a user input device. The method comprises detecting a rate of change of the pressure in order to control the assigning. What has been presented above with regard to the system and device similarly applies to the method in the invention. The method may be relevant to, e.g., a service provider who enables a user to interact with a server or other electronic equipment via a data network such as the Internet.

The invention further relates to control software for use with a data processing system comprising a pressure-sensitive input device for assigning a real value to a parameter under control of a pressure applied to the device. The software is operative to enable to control the assigning under control of the device detecting a rate of change of the pressure. The control software may be relevant to, e.g., upgrading electronic equipment to function according to the invention by means of having the control software downloaded or otherwise installed, e.g., as an after-market add-on.

### BRIEF DESCRIPTION OF THE DRAWING

The invention is explained in further detail, by way of example and with reference to the accompanying drawing wherein:

FIG. 1 is block diagram of a system in the invention; and

FIGS. 2-6 are graphs illustrating user input in terms of pressure variations.

Throughout the figures, same reference numerals indicate similar or corresponding features.

### DETAILED EMBODIMENTS

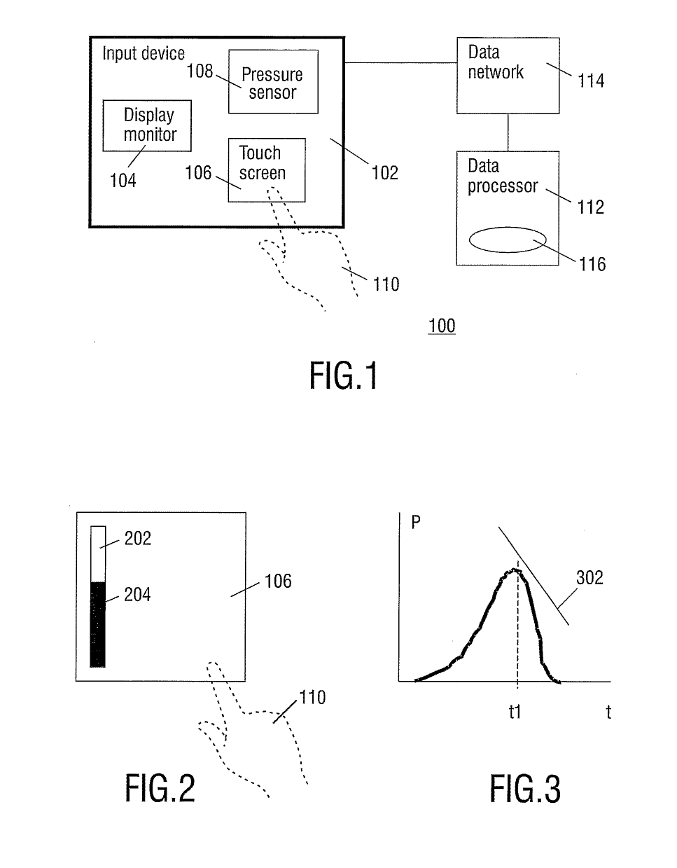

FIG. 1 is a block diagram of a data processing system 100 in the invention. System 100 comprises a user input device 102 that itself has a display monitor 104, a pressure-sensitive touch screen 106 and a pressure sensor 108. Touch screen 106 may, or may not, be positioned over display monitor 104. Which configuration is convenient depends on the application in operational use. Sensor 108 detects the magnitude of the pressure applied by user 110 to screen 106. System 100 further comprises a data processor 112 that is connected to device 102, e.g., via a data network 114 as in the drawing. In another embodiment, device 102 and processor 112 are directly connected, e.g., wirelessly or via a cable, or are integrated with one another within a single physical apparatus such as a cell phone or remote control device. Processor 112 in this example comprises control software 116 to have system 100 operate according to the invention.

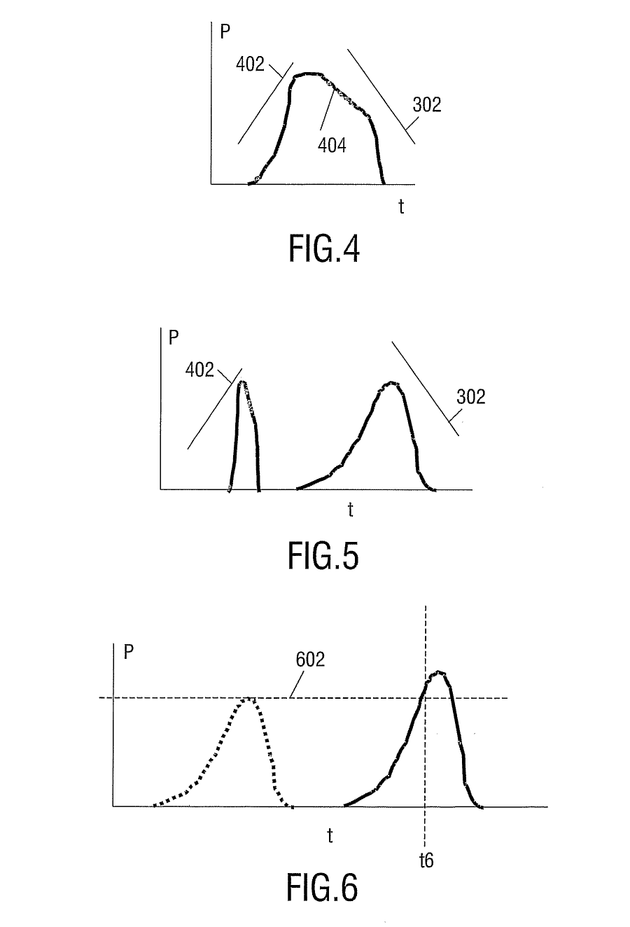

Operation of system 100 is explained with reference to FIGS. 2-4 that illustrate the process for an embodiment of control software 116 that implements a slider-application, wherein an increase in pressure registered by sensor 108 increases a value of a specific parameter, and a decrease in pressure registered by sensor 108 decreases the value. For simplicity, it is assumed that touch screen 106 and display monitor 104 are integrated with one another so that user 110 sees the images rendered on monitor 104 through touch screen 106.

In FIG. 2, an image 202 of a slider is rendered on monitor 104. The slider represents the range of real values that a specific parameter, e.g., volume of sound, light intensity, a temperature, or any other suitable physical quantity can assume under control of system 100. The current value of the parameter can be visualized in a variety of manners, one of which is shown here. The value here is indicated by the vertical extent of a black bar 204 within image 202. The combination is reminiscent of, for example, reading out a mercury thermometer.

FIG. 3 illustrates the pressure “p” as a function of time “t”. User 110 applies the pressure at a certain location of touch screen 106. In order for user 110 to set the parameter at the desired value, indicated in FIG. 2, user 110 increases the pressure until the desired level is reached. Monitor 104 provides visual feedback to user 110. Upon reaching this level, at a time t1, user 110 rapidly lowers the pressure at a rate below a predetermined rate. That is, the variation of the pressure per unit time is negative and larger in magnitude than a predetermined threshold. Still in other words, the tangent to the graph of the pressure versus the time at the point of starting a rapid decrease in pressure is steeper than a slanted line 302, representative of the predetermined rate or aforesaid threshold. This indicates to system 100 that user 110 does not want to decrease the value as would be the case if the pressure were decreased more gently, but instead wants to validate, or set, the value reached before the rapid decrease occurred.

Assume that the value of the parameter has been validated and set to the value of FIG. 2 and that, after a while, user 110 wants to lower the value. FIG. 4 illustrates this in a first embodiment with a graph of the pressure as a function of the time. In order to unlock the set value, i.e., in order to render the previously assigned value changeable, user 110 increases the pressure more rapidly than a certain amount per unit time as indicated by a line segment 402. Upon system 100 detecting the rate of change being larger than this predetermined value, the value is unlocked and user 110 can change, e.g., lower it as in the example shown by decreasing the pressure steadily according to segment 404. Once the desired value of the parameter has been reached, as indicated through visual feedback via monitor 104, the user may quickly lower the pressure so as to lock the value then attained as discussed under FIG. 3. Note that in this scenario the absolute value of the magnitude of the pressure need not be relevant as the rate of change is the controlling entity and user 110 is assisted through the visual feedback. FIG. 5 illustrates a second embodiment, wherein user 110 unlocks the value by means of rapidly increasing and thereupon rapidly decreasing the pressure. For example, user 110 may just tap on touch screen 106. Once unlocked, the user may steadily increase the pressure to increase the value above the one set previously and lock it by rapidly decreasing the pressure. If user 110 wants to decrease the value instead, two taps in rapid succession are supplied to signal to system 100 that the value is to be unlocked and subsequently lowered. System 100 now translates the next steady increase in pressure as a decrease in value. That is, the second tap serves to reverse the polarity of the change in value in response to an increase in pressure applied after the second tap. Again, this scenario uses relative values of the magnitude of the pressure for an absolute increase or decrease in the value of the parameter. FIG. 6 illustrates a third scenario. Assume that user 110 has set the value of the parameter according to the process of FIG. 3. In order for user 110 to be able to change the value, e.g., increase the value, user 110 has to apply a pressure larger than the threshold pressure 602 associated with the value previously set. Upon exceeding this level at moment t6, the value gets unlocked and can be set to a larger value by means of rapidly decreasing the pressure once the new value has been reached (similar to the FIG. 3 scenario), or can be lowered by gently lowering the pressure (similar to the FIG. 4 scenario). In this case, the absolute value of the magnitude of the pressure does matter, as there is a one-to-one correspondence with the parameter's value.

Preferably predetermined rates 302 and 402 are programmable so that the settings can be made to comply with preferences of individual users.

In the examples above, the pressure-sensitive input device comprises a touch screen. Other examples of pressure-sensitive input devices can be used as well, e.g., a trackball as in U.S. Pat. No. 5,781,172 (attorney docket PHN 13,522) or U.S. Pat. No. 5,784,052 (attorney docket PHN 15,232), both incorporated herein by reference, or a joystick, etc.

In this text, the word “real” as in the term “real value” indicates a number that can contain a fractional part. In a computer, a real number is typically represented as a floating-point value. The name “floating-point” refers to the fact that there are not a fixed number of digits before or behind the decimal point. Another manner of representing a real number in a computer is by means of a fixed-point representation, wherein there is a fixed number of digits before and/or after the decimal point.

The term “touch screen” as used in this text is also to include graphical tablets, e.g., stylus-operated. What has been discussed above with regard to touch screens that interact with the user's finger is also applicable to graphical tablets.

1. A data processing system comprising a pressure-sensitive input device for assigning a real value to a parameter under control of a pressure applied to the device, the system being operative to detect a rate of change of the pressure to control the assigning.

2. The system of claim 1, operative to set the parameter to the value assigned prior to detecting the rate of change being larger than a predetermined rate.

3. The system of claim 1, operative to render the value, previously assigned, changeable upon detecting the rate of change being larger than a predetermined value.

4. The system of claim 1, operative to render the value, previously assigned, changeable upon detecting a first magnitude of the pressure being larger than a second magnitude of the pressure corresponding to the assigned value.

5. The system of claim 1, wherein the device comprises a touch screen.

6. The system of claim 1, accommodated in a remote control device.

7. The system of claim 2, wherein the predetermined value is programmable.

8. The system of claim 3, wherein the predetermined value is programmable.

9. A pressure-sensitive input device for assigning a real value to a parameter under control of a pressure applied to the device, the device being operative to detect a rate of change of the pressure to control the assigning.

10. The device of claim 9, operative to set the parameter to the value assigned prior to detecting the rate of change being larger than a predetermined rate.

11. The device of claim 9, operative to render the value, previously assigned, changeable upon detecting the rate of change being larger than a predetermined value.

12. The device of claim 9, operative to render the value, previously assigned, changeable upon detecting a first magnitude of the pressure being larger than a second magnitude of the pressure corresponding to the assigned value.

13. The device of claim 9, comprising a touch screen.

14. The device of claim 9, accommodated in a remote control device.

15. The device of claim 11, wherein the predetermined value is programmable.

16. The device of claim 12, wherein the predetermined value is programmable.

17. A method of enabling to assign a real value to a parameter under control of a pressure applied to a user input device, the method comprising detecting a rate of change of the pressure in order to control the assigning.

18. Control software for use with a data processing system comprising a pressure-sensitive input device for assigning a real value to a parameter under control of a pressure applied to the device, the software being operative to enable to control the assigning under control of the device detecting a rate of change of the pressure.
